(19) United States
(12) Patent Application Publication
(10) Pub. No.: US 2012/0135714 A1
(43) Pub. Date: May 31, 2012

(54) INFORMATION SYSTEM FOR MOTOR VEHICLE

(75) Inventor: Charles Joseph King, II, Saline, MI (US)

(73) Assignee: Toyota Motor Engineering & Manufacturing North America, Inc., Erlanger, KY (US)

(21) Appl. No.: 12/955,098

(22) Filed: Nov. 29, 2010

(51) Int. Cl. H04L 12/58; H04W 4/00; G01C 21/00

(52) U.S. Cl. 455/412.1

(57) ABSTRACT

An information system for a motor vehicle is provided. The information system can include an on-board information system operable to accept input information, conduct a search and provide output information to an individual within the motor vehicle. In addition, an on-board hands free phone system can be included and be operable to communicate with an off-board phone and record and/or stream an utterance communicated by a user of said off-board phone. The on-board hands fee phone system can record/stream the utterance using a recording and/or streaming function, e.g. through the use of a Record and/or Stream button and/or a voice activated Record and/or Stream command. The recorded and/or streamed utterance can be provided to a voice recognition system that can translate the utterance into input information for the on-board information system which can then conduct the search and provide output information for an occupant of the motor vehicle.

### FIELD OF THE INVENTION

The present invention relates to an information system for a motor vehicle, and in particular, an information system that can extract information from voice data originating from an off-board phone.

### BACKGROUND OF THE INVENTION

Information systems for motor vehicles are known. For example, navigation systems, radios, internet interfaces, DVD players and the like are known to be available in selected vehicles. In addition, the use of such systems can provide convenience, entertainment and/or safety to one or more occupants within the vehicle during driving thereof. At the same time, the use of such systems by a driver of the vehicle is typically not recommended when he or she must take at least one hand off of a steering wheel while the vehicle is moving since such an action can reduce the alertness, effectiveness, etc., of the individual's driving. In addition, concern among vehicle safety groups, city and state governments, and the like has been generated and publicized regarding drivers that use such systems during driving.

In response to individuals desiring such above-listed systems in their vehicles, and yet the need to maintain high safety standards, vehicle manufacturers have developed hands-free phone systems that allow a driver to maintain both hands on the steering wheel while talking to an off-board phone. However, it is not uncommon for the driver to receive information while talking on the hands-free phone and desire to input the information, e.g. an address, into a separate information system within the vehicle, e.g. a navigation system. In addition, the task of entering the information into the information system can result in the driver removing his or her hand from the steering wheel and thus reduce the safety of his or her driving. As such, an information system that affords for hands-free entering of voice recognizable data would be desirable.

### SUMMARY OF THE INVENTION

An information system for a motor vehicle is provided. The information system can include an on-board information system operable to accept input information, conduct a search and provide output information to an individual within the motor vehicle. In addition, an on-board hands free phone system can be included and be operable to communicate with an off-board phone and record and/or stream an utterance communicated by a user of said off-board phone. The on-board hands free phone system can record and/or stream the utterance using a recording and/or streaming function, e.g. through the use of a Record and/or Stream button and/or a voice activated Record and/or Stream command. The recorded and/or streamed utterance can be provided to a voice recognition system that can translate the utterance into input information for the on-board information system which can then conduct the search and provide output information for an occupant of the motor vehicle.

In some instances the on-board information system can be an on-board navigation system and the input information can be an address, a restaurant name, a retail store name, a school name, a sporting facility name, an airport name, an entertainment facility name and the like. The output information can be travel or driving directions to the input information.

In other instances the on-board information system can be an on-board radio and/or compact disc (CD) system and the input information can be a radio station name, a talk show title, a musical song title, a musician name and the like. The output information can be a radio station's dial identification.

In still other instances, the on-board information system can be an on-board interne interface system and the input information can be a topic of interest, a place of interest, a stock market symbol, an airline flight number, a train number, a subway number, a restaurant menu and the like. The output information can be an interest search result and/or a website.

In operation, a driver of the motor vehicle can use the on-board hands free phone system to communicate a second party on an off-board phone system. During the communication, the driver can record and/or stream a utterance by the second party and the utterance can be submitted to the voice recognition system for translation into input information. Once translated, the input information can be submitted to the on-board information system which can perform a search and provide output information to the driver. It is appreciated that entire operation can be performed with the driver maintaining both hands on a steering wheel of the motor vehicle.

### BRIEF DESCRIPTION OF THE DRAWINGS

FIG. 1 is schematic diagram illustrating an information system for a motor vehicle according to an embodiment of the present invention; and

FIG. 2 is a schematic flowchart illustrating a process for using an information system for a motor vehicle according to an embodiment of the present invention.

### DETAILED DESCRIPTION OF THE INVENTION

The present invention discloses an information system for a motor vehicle. As such, the present invention has utility as a component for the motor vehicle.

The information system can include an on-board information system operable to accept input information, conduct a search and provide output information to an individual or a first party, e.g. the driver, within the motor vehicle. The information system can include an on-board hands free phone system and a recording and/or streaming (hereafter referred to simply as recording/streaming) function that can record and/or stream (hereafter referred to simply as record/stream) an utterance communicated by a second party using an off-board phone in communication with the on-board hands free phone system. The recording/streaming function may or may not be part of the on-board hands free phone system and can include a RECORD and/or a STREAM (hereafter simply referred to simply as RECORD/STREAM) button and/or a voice activated RECORD/STREAM command.

The recorded and/or streamed (hereafter referred to simply as recorded/streamed) utterance can be provided to a voice recognition system having a voice recognition engine that can translate the utterance into input information for the on-board information system. Once the input information is received by the on-board information system, a search can be performed and output information can be provided to the individual within the motor vehicle.

In some instances the on-board information system can be an on-board navigation system and the input information can be an address, a restaurant name, a retail store name, a school name, a sporting facility name, an airport name, an entertainment facility name and the like. The output information can be travel or driving directions to the input information.

In other instances the on-board information system can be an on-board radio and/or compact disc (CD) system and the input information can be a radio station name, a talk show title, a musical song title and a musician name. The output information can be a radio station's dial or numerical identification.

In still other instances, the on-board information system can be an on-board internet interface system and the input information can be a topic of interest, a place of interest, a stock market symbol, an airline flight number, a train number, a subway number, a restaurant menu and the like. The output information can be an internet search result and/or a website.

In operation, a driver of the motor vehicle can use the on-board hands free phone system to communicate with the second party using an off-board phone system. During the communication, the driver can record/stream an utterance by the second party and the utterance can be submitted to the voice recognition system for translation into input information. Once translated, the input information can be submitted to the on-board information system which can perform a search and provide output information to the driver. It is appreciated that the entire operation can be performed with the driver maintaining both hands on a steering wheel of the motor vehicle.

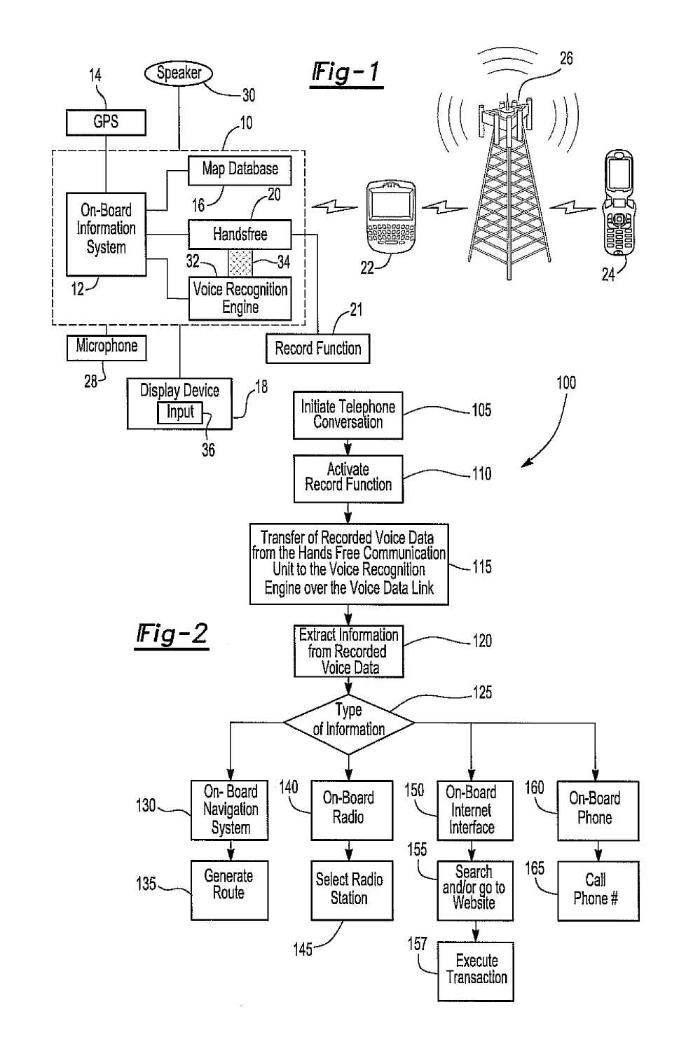

Referring now to FIG. 1, the inventive on-board information is shown generally at reference numeral 10. The information system can include an on-board information unit 12 which can be in the form of a navigation system, a radio/compact disc (CD) system, an internet interface system and the like.

In the event that the on-board information unit 12 is a navigation system, the information unit can be a route generation module and a GPS receiver 14 and a map database 16 can be included. It is appreciated that the GPS receiver 14 and the map database 16 can be in communication with the navigation system which is operable to generate a route as is known to those skilled in the art. It is further appreciated that the GPS receiver 14 can receive various types of signals originating from a plurality of GPS satellites orbiting the Earth, the signals affording determination of the current location of the vehicle.

The map database 16 can include various map information specifying the intersections of the road configurations utilizing links, nodes, and the like. The map information further includes address information, names of facilities, and phone numbers linked to specific addresses so as to use as a destination. In some instances, the map database 16 can be recorded on a hard disk drive, flash drive DVD, CD, etc., thereby allowing map information to be updated on a regular basis by the insertion of a flash drive, DVD, CD, etc.

Upon receipt of a route destination, the unit 12 can communicate with the GPS receiver 14 to determine the vehicle's current location and access the map database 16 in order to obtain map information for both the current location and the route destination. The unit 12 can then generate a navigational route from the current location of the vehicle to the inputted route destination.

The information system 10 can include a display device 18 acting as an input/output interface between the occupant and the system 10. It is appreciated that the display device 18 optionally includes a touch panel display configured to display various data and allow the occupant to enter data, such as either a route destination or a call destination.

The information system 10 further includes an on-board hands-free communication unit 20 that may or may not be connected to a host communication device 22 in either a wired or wireless manner. For example and for illustrative purposes only, the host communication device 22 can be a driver's or passenger's cellular telephone which can be connected to a separate phone via a remote communication device 24 over a communication network 26, such as a cellular network, Wi-Fi network and the like. The hands free communication unit 20 can communicate with the host communication device 22 through the use of a Bluetooth communication link, although other communication methods and protocols are within the scope of the invention.

It is appreciated, that the host communication device 22 can be a computer and the communication network 26 can be the internet such that internet communications are provided. The remote communication device 24 is either a telephone device including a cellular telephone, a land line telephone, or a computer connected to the communication network 26, which is disposed remote from the vehicle and consequently the host communication device 22.

The hands free communication device 20 can connect the host communication device 22 with a microphone 28 and a speaker 30 disposed within the passenger compartment of the automotive vehicle. The hands free communication unit 20 allows the occupant to participate in a cellular phone conversation with the second party through the microphone 28 which picks up the voice uttered by the occupant of the vehicle, and the speaker 30 which outputs the voice uttered by the second party to the telephone conversation. It should be appreciated that the speaker 30 can be audio system speakers of the automotive vehicle that afford the driver and/or occupant to hear or listen to the second party of a phone conversation through the audio system speakers.

The information system 10 can have a recording/streaming function 21 (shown only as Record Function in the figure) that can record/stream an utterance communication to the hands free communication unit 20, e.g. by the second party using the remote communication device 24. The recording/streaming function may or may not be part of the on-board hands free communication unit 20 and can be in the form of a RECORD/STREAM button and/or a voice activated RECORD/STREAM command that can be executed by the driver of the motor vehicle.

The information system 10 can further include a voice recognition system or engine 32. The voice recognition engine 32 and recording/streaming function unit 21 can be connected through a voice data link 34 that affords the voice recognition engine 32 to receive recorded/streamed utterance data, e.g. recorded/streamed voice data uttered by the second party during a telephone conversation. In addition, the voice data link 34 can result in the voice recognition engine 32 processing the recorded/streamed voice data without a reduction in quality typically associated with voice data uttered during a telephone conversation, outputted from a cell phone, picked up by a microphone and then transmitted to a voice recognition engine. It is appreciated that the voice data link 34 can be a wired connection between the voice recognition engine 32 and the recording/streaming function unit 21.

In the alternative, the voice data link 34 can be a wireless connection through the use of a Bluetooth communication link, although other communication methods and protocols are within the scope of the invention. If a wireless connection is employed, the voice recognition engine 32 can be disposed on a server remote from the vehicle with the voice data link 34 transmitting the recorded/streamed voice data through a data communication module. In addition, the recorded/streamed voice data can be transmitted over the voice data link 34 to the remote server where the voice recognition engine 32 processes the recorded/streamed voice data to extract information and provide input information for the on-board information system 12. The input information can be then transmitted from the voice recognition engine 32 on the remote server to the information system 10 via the data communication module and provided to the on-board information system 12. It is appreciated that the data communication module illustratively can include a communication device such as a cellular telephone or a computer utilizing a cellular or internet communication network 26.

The voice recognition engine 32 can utilize any known voice/speech recognition software capable of converting spoken words into text from which information can be extracted. In the alternative, the voice recognition engine 32 can phonetically compare voice data to a list of information entries to extract the information. The information entries can be optionally stored on the on-board information unit 12 which is accessed by the voice recognition engine 32.

The input information can be information used by an on-board navigation system, an on-board radio/CD system, an on-board internet interface system, the on-board hands free phone system and the like. For example and for illustrative purposes only, the input information can be an address, a restaurant name, a retail store name, a school name, a sporting facility name, an airport name, an entertainment facility name, longitude and latitude coordinates, a telephone number associated with a specific address, a closest type of business (“nearest gas station”), a specific person's name, an address associated with a specific telephone number and the like that can be provided by an on-board navigation system in order to obtain directions to a desired location.

In the alternative, input information can be a radio station name, a talk show title, a musical song title, a musician name and the like that can be provided to an on-board radio/CD system in order for the radio/CD system to select and/or play a particular song, radio station, etc. In still another alternative, input information can be a topic of interest, a place of interest, a stock market symbol, an airline flight number, a train number, a subway number, a restaurant menu and the like that can be provided to an on-board internet interface system in order for the internet interface system to conduct an internet search and provide a search result, website, etc.

The input information can be displayed on the display device 18 where the driver can activate an input function 36 such that the input information is provided to the on-board information system 12. It is appreciated that a motor vehicle can have more than one on-board information system and the driver can select which information system receives the input information displayed on the display device 18, e.g. by using the input function 36. It is further appreciated that the input function can be in the form or a button or tab to be pressed, pushed and/or pulled upon by the driver and/or a voice activated function.

In order to facilitate a better understanding of the present invention, a process of extracting input information from voice data uttered by the second party via the remote communication device 24 remote from the vehicle is shown in FIG. 2. In step 105, a telephone conversation is initiated between the host communication device 22 and the remote communication device 24. The telephone call is initiated either through the occupant of the vehicle calling a remote party or the occupant answering a telephone call from the remote party. The hands free communication unit 20 allows the driver to dial or answer the call through voice input, and once the phone call is initiated the occupant can conduct the phone call through the speakers 30 and the microphone 28. It is appreciated, of course, that the telephone conversation can be initiated without connection to the hands free communication unit 20, which is later connected in order to extract the input information.

At step 110 the recording/streaming function 21 can be activated and an utterance from the remote party recorded/streamed. It is appreciated that the utterance can originate from or the remote party can be an individual, a computer generated voice and the like. During a conversation with the remote party, the driver can desire to the on-board information system 12 to perform a search and provide output information. As such, the driver can record/stream at least a portion of the conversation, the recorded/streamed utterance then transferred to the voice recognition unit 32 at step 115.

The voice recognition unit 32 can then translate the utterance and extract input information at step 120. Thereafter, the type of input information can be determined by the driver and/or an artificial intelligence system that is part of the system 10 at step 120. Once the type of input information has been determined, it can be relayed and/or provide to the on-board information system 12 at step 130 for an on-board navigation system, at step 140 for an on-board radio/CD system, at step 150 for on-board internet interface system or at step 160 for the on-board phone system.

At step 135, the on-board navigation system can generate a route that can be taken by the driver to arrive at a desired location. At step 145, the on-board radio/CD system can select and/or play a desired radio station, CD and the like. At step 155, the on-board internet interface can perform a search and/or go to a desired website, optionally followed by executing a desired transaction such as making restaurant reservations, purchasing theater tickets, etc. And at step 160, the on-board phone system can call a desired phone number or route to and/or display a desired phone number.

The invention has been described in an illustrative manner. It is therefore to be understood that the terminology used is intended to be in the nature of words of description rather than of limitation. Many modifications and variations of the invention are possible in light of the above teachings. Thus within the scope of the appended claims the invention may be practiced other than as specifically described.

It is claimed:

1. An information system for a motor vehicle in communication with an off-board phone comprising:
an on-board information system having at least one of a navigation system, a radio, a compact disc (CD) system and an internet interface system;
an on-board hands free phone system operable to communicate with the off-board phone and record/stream an utterance communicated by a user of the off-board phone;
a voice recognition system having a translation module operable to translate said recorded/streamed utterance and a delivery module operable to deliver said translated recorded/streamed utterance as input information to said on-board information system;
said on-board information system operable to accept said input information from said delivery module, conduct a search and provide output information to an individual within the motor vehicle.

2. (canceled)

3. The information system of claim 1, wherein said input information is selected from a group consisting of an address, a restaurant name, a retail store name, a school name, a sporting facility name, an airport name and an entertainment facility name, and said output information is directions to said input information.

4. (canceled)

5. The information system of claim 1, wherein said input information is selected from a group consisting of a radio station name, a talk show title, a musical song title and a musician name.

6. (canceled)

7. The information system of claim 1, wherein said input information is selected from a group consisting of a topic of interest, a place of interest, a stock market symbol, an airline flight number, a train number, a subway number and a restaurant menu item.

8. The information system of claim 1, wherein said on-board hands free phone system has a recording/streaming function.

9. The information system of claim 8, wherein said recording/streaming function is in the form of a Record/Stream button.

10. The information system of claim 8, wherein said recording/streaming function is voice activated.

11. A process for a driver of a motor vehicle to obtain and use off-board information, the process comprising:
providing an on-board information system having at least one of a navigation system, a radio, a compact disc (CD) system and an internet interface system;
providing an on-board hands free phone system operable to communicate with an off-board phone and record/stream an utterance communicated by a user of said off-board phone;
providing a voice recognition system having a translation module operable to translate said recorded/streamed utterance and a delivery module operable to deliver said translated recorded/streamed utterance as input information to said on-board information system said on-board information system operable to accept said input information from said delivery module, conduct a search and provide output information to an individual within the motor vehicle;
using the on-board hands free phone system to communicate with a remote party using the off-board phone;
recording/streaming an utterance provided by the remote party;
providing the recorded/streamed utterance to the voice recognition system, the voice recognition system translating the recorded/streamed utterance and providing input information; and
providing the input information to the on-board information system, the on-board information system conducting a search and providing output information to the individual.

12. The process of claim 11, wherein the utterance is selected from a group consisting of an address, a restaurant name, a retail store name, a school name, a sporting facility name, an airport name and an entertainment facility name, and the output information is a set of driving directions.

13. The process of claim 11, wherein the utterance is selected from a group consisting of a radio station name, a talk show title, a musical song title and a musician name, and the output information is a radio station identifier.

14. The process of claim 11, wherein the utterance is selected from a group consisting of a topic of interest, a place of interest, a stock market symbol, an airline flight number, a train number, a subway number and a restaurant menu item and the output information is an internet search result.
